(19) United States
(12) Patent Application Publication
(10) Pub. No.: US 2025/0391593 A1
(43) Pub. Date: Dec. 25, 2025

(54) ELECTRONIC COMPONENT AND METHOD FOR MANUFACTURING SAME

(71) Applicant: Panasonic Intellectual Property Management Co., Ltd., Osaka (JP)

(72) Inventors: YASUTAKA OKAMOTO, Hokkaido (JP); KEN YANAI, Hokkaido (JP); SATOSHI KAWAMURA, Hokkaido (JP); YUJI KURACHI, Hokkaido (JP)

(21) Appl. No.: 19/306,881

(22) Filed: Aug. 21, 2025

Related U.S. Application Data
(63) Continuation of application No. PCT/JP2024/009400, filed on Mar. 11, 2024.

(30) Foreign Application Priority Data
Mar. 30, 2023 (JP) 2023-056705

(51) Int. Cl. H01C 1/142; H01C 1/02; H01C 7/10; H01C 17/28

(52) U.S. Cl. CPC H01C 1/142; H01C 1/02; H01C 7/10; H01C 17/288

(57) ABSTRACT

The occurrence of granular plating due to reflow heating during mounting is suppressed. An electronic component includes an electric element, a frame terminal, and an exterior body. The frame terminal includes a plating layer on a surface of the frame terminal, and is electrically connected to the electric element. The exterior body covers the electric element and a part of the frame terminal. The frame terminal includes a covered portion, and an exposed portion exposed from the side surface of the exterior body. The exposed portion includes a first bent portion where the frame terminal is bent along the side surface, and a first extension portion extending from the first bent portion toward the bottom surface of the exterior body. The plating layer near the first bent portion of the first extension portion has a thickness greater than a thickness of the plating layer in the covered portion.

### BACKGROUND

### 1. Technical Field

The present disclosure relates to an electronic component and a method for manufacturing the electronic component. Specifically, the present disclosure relates to an electronic component including an electric element, a frame terminal, and an exterior body, and a method for manufacturing the electronic component.

### 2. Description of the Related Art

An electric element such as a multilayer varistor is used to protect an electronic circuit used for automobiles, industrial equipment, and the like from unexpected noise or pulses. In order to improve reliability such as heat resistance and moisture resistance of such an electric element, the electric element is covered with an exterior body. In addition, in order to enable surface mounting on a circuit board, an electronic component to which a frame terminal is attached is used.

As an example of such an electronic component, PTL 1 discloses a varistor in which a varistor element, an external electrode disposed on a surface of the varistor element, and a pair of frame terminals joined to the external electrode are covered with an insulating exterior body.

### CITATION LIST

### Patent Literature

PTL 1: Unexamined Japanese Patent Publication No. 2017-54868

### SUMMARY

However, in a conventional electronic component such as the varistor described in PTL 1, granular plating may occur near the bent portion of the frame terminal due to the plating layer of the frame terminal during the heat treatment of reflow mounting. Such granular plating falls off due to low adhesion, and may cause short circuit or the like on the mount board.

An object of the present disclosure is to provide an electronic component capable of suppressing occurrence of granular plating due to reflow heating during mounting, and a method for manufacturing the electronic component.

An electronic component according to an aspect of the present disclosure includes an electric element, a frame terminal that includes a plating layer on a surface of the frame terminal, and is electrically connected to the electric element, and an exterior body having insulation properties that covers the electric element and a part of the frame terminal, and has a side surface and a bottom surface. The frame terminal includes a covered portion covered with the exterior body, and an exposed portion exposed from the side surface of the exterior body. The exposed portion includes a first bent portion where the frame terminal led out from the exterior body is bent along the side surface, and a first extension portion extending from the first bent portion toward the bottom surface of the exterior body. The plating layer near the first bent portion of the first extension portion has a thickness greater than a thickness of the plating layer in the covered portion.

The method for manufacturing an electronic component according to another aspect of the present disclosure includes a first step, a second step, a third step, a fourth step, a fifth step, and a sixth step. In the first step, an electric element is prepared. In the second step, a frame terminal including a plating layer on a surface is prepared. In the third step, the electric element and the frame terminal are electrically connected. In the fourth step, by covering the electric element and a part of the frame terminal with an exterior body having insulation properties, a covered portion covered with the exterior body and an exposed portion exposed from a side surface of the exterior body are formed in the frame terminal. In the fifth step, the electric element and the frame terminal covered with the exterior body are subjected to heat treatment at a temperature equal to or greater than the melting point of the plating layer. In a sixth step after the fifth step, the frame terminal is bent along a side surface of the exterior body at the exposed portion.

According to the electronic component and the manufacturing method thereof the present disclosure, it is possible to provide an electronic component capable of suppressing occurrence of granular plating due to reflow heating during mounting, and a method for manufacturing the electronic component.

### BRIEF DESCRIPTION OF THE DRAWINGS

FIG. 1A is a schematic perspective view of an electronic component according to an exemplary embodiment of the present disclosure;

FIG. 1B is a schematic sectional view of the electronic component according to the exemplary embodiment of the present disclosure;

FIG. 2A is a schematic sectional view illustrating a structure of a frame terminal before heat treatment in the electronic component according to the exemplary embodiment of the present disclosure;

FIG. 2B is a schematic sectional view illustrating a structure of the frame terminal after the heat treatment in the electronic component according to the exemplary embodiment of the present disclosure;

FIG. 3A is a schematic sectional view illustrating a structure of the frame terminal before bending in the electronic component according to the exemplary embodiment of the present disclosure;

FIG. 3B is a schematic sectional view illustrating a structure of the frame terminal after bending in the electronic component according to the exemplary embodiment of the present disclosure;

FIG. 4A is a schematic sectional view illustrating a structure of the frame terminal before bending in the conventional electronic component; and

FIG. 4B is a schematic sectional view illustrating a structure of the frame terminal after bending in the conventional electronic component.

### DETAILED DESCRIPTIONS

### 1. Overview

Hereinafter, an electronic component and a method for manufacturing the electronic component according to an exemplary embodiment of the present disclosure will be described with reference to the drawings. Note that the drawings described in the following exemplary embodiments are schematic views, and the ratios of the sizes and the thicknesses of the components in the drawings do not necessarily reflect the actual dimensional ratios.

In the present disclosure, a “side surface” of exterior body 31 indicates a surface including a portion where frame terminal 21 is exposed on the surfaces of exterior body 31. A “bottom surface” of exterior body 31 indicates a lower surface of exterior body 31.

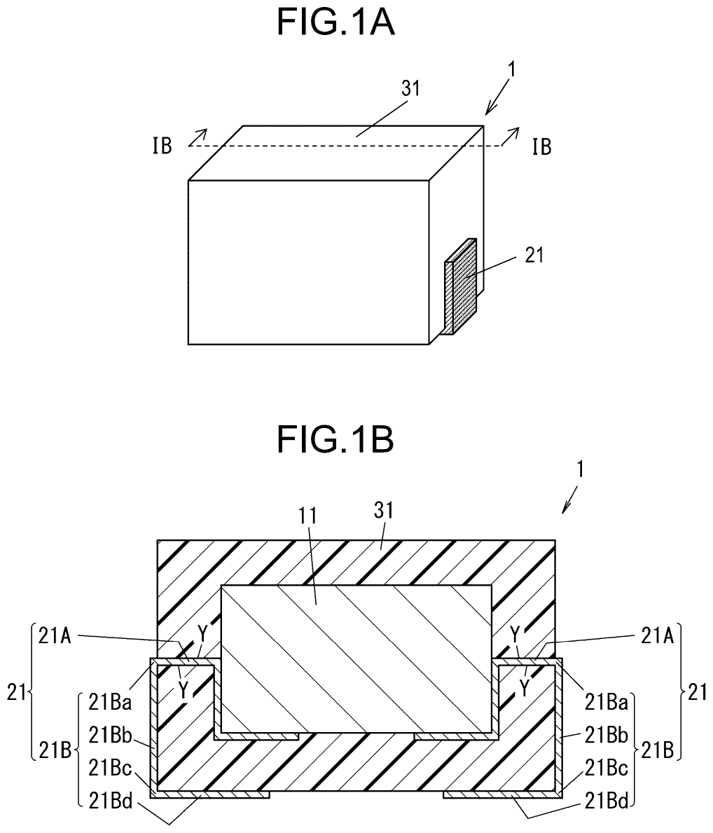

FIG. 1A shows a schematic perspective view of electronic component 1 according to the present exemplary embodiment. FIG. 1B shows a schematic sectional view of electronic component 1 according to the present exemplary embodiment. FIG. 1B is a sectional view of the electronic component shown in FIG. 1A taken along a plane passing through straight line IB-IB perpendicular to an end surface where frame terminal 21 is located and perpendicular to an upper surface of the electronic component. As shown in FIGS. 1A and 1B, electronic component 1 of the present exemplary embodiment includes electric element 11, frame terminal 21 including a plating layer (hereinafter, also referred to as plating layer Y) on a surface of the frame terminal 21, and exterior body 31. Frame terminal 21 includes covered portion 21A covered with exterior body 31 and exposed portion 21B exposed from a side surface of exterior body 31. Exposed portion 21B includes first bent portion 21Ba where frame terminal 21 led out from exterior body 31 is bent along the side surface of exterior body 31, and first extension portion 21Bb extending from first bent portion 21Ba toward a bottom surface of exterior body 31. Electronic component 1 of the present exemplary embodiment has a feature that a thickness of plating layer Y near first bent portion 21Ba of first extension portion 21Bb is greater than a thickness of plating layer Y in covered portion 21A.

The method for manufacturing electronic component 1 of the present exemplary embodiment includes a first step to a sixth step. The first step is a step of preparing electric element 11. The second step is a step of preparing frame terminal 21 including a plating layer Y on a surface. The third step is a step of electrically connecting electric element 11 and frame terminal 21. The fourth step is a step of covering electric clement 11 and a part of frame terminal 21 with exterior body 31 having insulation properties, and forming covered portion 21A covered with exterior body 31 and exposed portion 21B exposed from a side surface of exterior body 31 in frame terminal 21. The fifth step is a step of performing heat treatment to electric element 11 and frame terminal 21 covered with exterior body 31 at a temperature equal to or greater than a melting point of plating layer Y. The sixth step is a step of bending frame terminal 21 along a side surface of exterior body 31 in exposed portion 21B after the fifth step.

According to electronic component 1 and the method for manufacturing an electronic component 1 of the present exemplary embodiment, occurrence of granular plating due to reflow heating during mounting can be suppressed. The reason why electronic component 1 and the method for manufacturing electronic component 1 exhibit the above effect by having the above configuration is not necessarily clear, but for example, it can be inferred as described below.

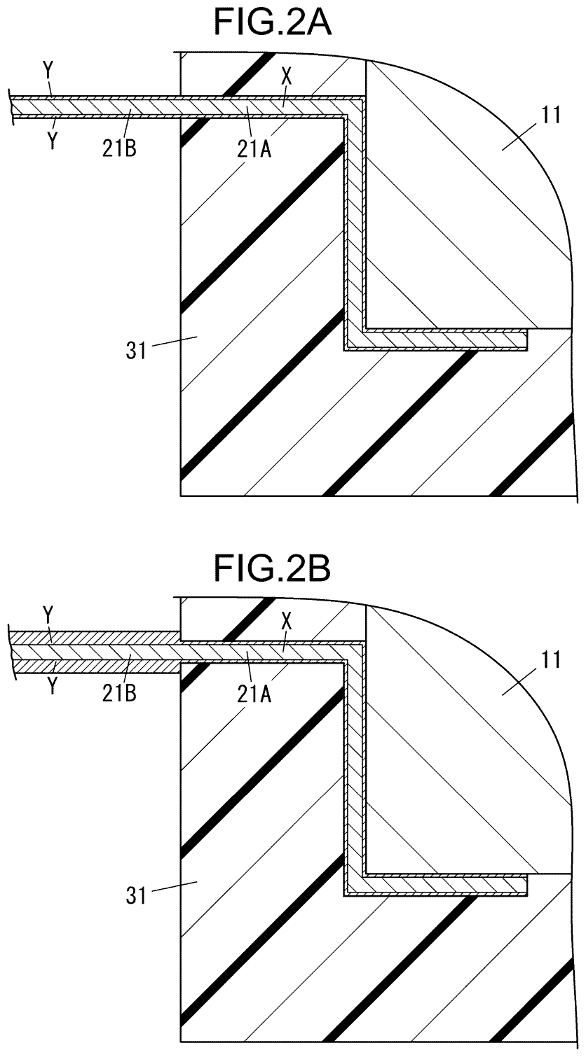

In the present exemplary embodiment, before frame terminal 21 is bent, heat treatment for heating exterior body 31 including electric element 11 and frame terminal 21 therein to a temperature equal to or greater than the melting point of plating layer Y is performed. The change in the structure such as the thickness of plating layer Y in frame terminal 21 before and after the heat treatment is shown in FIGS. 2A (before heat treatment) and 2B (after heat treatment). That is, FIG. 2A is a schematic sectional view for explaining the structure of frame terminal 21 before heat treatment in electronic component 1 of the present exemplary embodiment. FIG. 2B is a schematic sectional view illustrating a structure of frame terminal 21 after the heat treatment in electronic component 1 of the present exemplary embodiment.

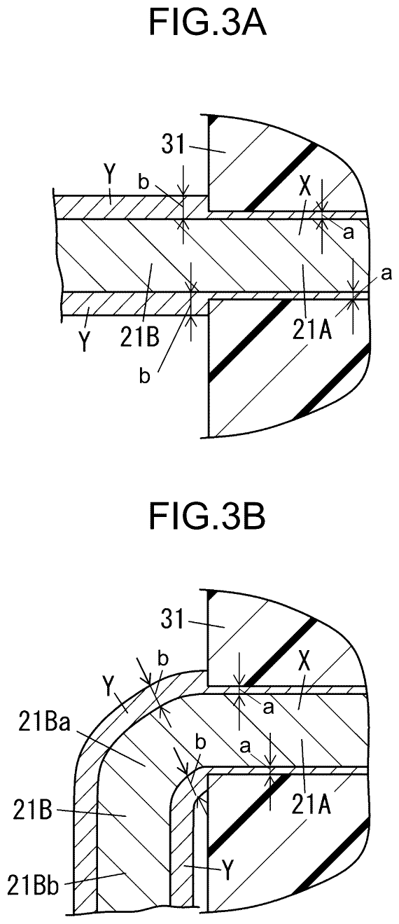

FIGS. 3A and 3B illustrate the structures before and after bending of frame terminal 21 of electronic component 1 of the present exemplary embodiment. That is, FIG. 3A is a schematic sectional view illustrating a structure before frame terminal 21 is bent in electronic component 1 of the present exemplary embodiment. FIG. 3B is a schematic sectional view illustrating a structure of frame terminal 21 after bending in electronic component 1 of the present exemplary embodiment.

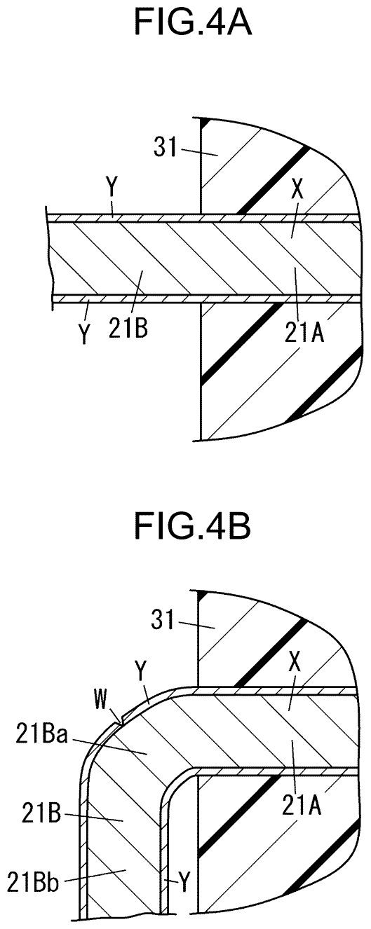

FIGS. 4A and 4B illustrate structures before and after bending of a frame terminal of a conventional electronic component. That is, FIG. 4A is a schematic sectional view illustrating a structure of a conventional electronic component before a frame terminal is bent. FIG. 4B is a schematic sectional view illustrating a structure of the conventional electronic component after the frame terminal is bent.

Unlike the present exemplary embodiment, in the conventional electronic component, the frame terminal is bent without performing the heat treatment as described above. As described above, since frame terminal 21 is bent in a state where the thickness of plating layer Y at exposed portion 21B of frame terminal 21 outside exterior body 31 is small as illustrated in FIG. 4A, it is considered that crack W occurs in plating layer Y at a bent portion (corresponding to first bent portion 21Ba of the present exemplary embodiment) as illustrated in FIG. 4B. In such a conventional electronic component, since plating layer Y which has been melted moving from covered portion 21A of frame terminal 21 to exposed portion 21B as described later cannot be wet and spread due to crack W during reflow heating at the time of mounting, granular plating may occur.

On the other hand, in electronic component 1 of the present exemplary embodiment, frame terminal 21 is bent after heat treatment. By this heat treatment, plating layer Y in covered portion 21A of frame terminal 21 is melted, and plating layer Y which has been melted is discharged to the outside of exterior body 31 due to expansion of exterior body 31 and frame terminal 21, and moves to exposed portion 21B of frame terminal 21. As a result, as illustrated in FIG. 2B, the thickness of plating layer Y in exposed portion 21B of frame terminal 21 changes to be greater than the thickness of plating layer Y in covered portion 21A. That is, the thickness of plating layer Y near first bent portion 21Ba of first extension portion 21Bb of frame terminal 21 is greater than the thickness of plating layer Y in covered portion 21A. This heat treatment is performed before frame terminal 21 is bent. Since there is no crack in plating layer Y of exposed portion 21B of frame terminal 21, plating layer Y which has been melted and moved by the heat treatment can wet and spread over exposed portion 21B. Therefore, it is considered that the occurrence of granular plating is suppressed. Also, as shown in FIG. 3A, when frame terminal 21 is bent, the thickness of plating layer Y at the bent portion in the exposed portion 21B is increased. Therefore, it is considered that the occurrence of cracks in plating layer Y is also suppressed as illustrated in FIG. 3B when frame terminal 21 is bent. Furthermore, even in the case of reflow heating at the time of mounting to be performed thereafter, since there is no crack in plating layer Y of exposed portion 21B and there is almost no plating layer Y that can be melted from covered portion 21A and moved to exposed portion 21B, it is considered that occurrence of granular plating due to reflow heating at the time of mounting can be suppressed.

### 2. Details

### <Electronic Component>

Electronic component 1 includes electric element 11, frame terminal 21, and exterior body 31.

Each configuration will be described below.

### [Electric Element]

Since electric element 11 is covered with exterior body 31, reliability such as heat resistance and moisture resistance can be improved.

Electronic component 1 usually includes one electric element 11. However, the number of the electric elements 11 is not limited thereto, and may be two or more.

Electric element 11 may include, for example, a multilayer varistor and a solid electrolytic capacitor.

Electric element 11 is electrically connected to frame terminal 21. This electrical connection can be performed, for example, by bonding an external electrode disposed on a side surface, a bottom surface, or the like of the multilayer varistor, which is electric element 11, and frame terminal 21 with a conductive adhesive such as a silver paste.

[Exterior body]

Exterior body 31 is a member that covers electric element 11 and a part of frame terminal 21.

Exterior body 31 can be formed, for example, by transfer molding in which a thermosetting resin or the like including an inorganic filler such as an epoxy resin mixed with silica is injected under pressure into a mold in which electric element 11 and frame terminal 21 are arranged.

### [Frame Terminal]

Frame terminal 21 is a thin plate-shaped conductive member used for electrically connecting electric element 11 and the surface where electronic component 1 is mounted. A width (dimension in the direction orthogonal to the length direction) of frame terminal 21 is, for example, equal to or greater than 0.1 mm and equal to or less than 20 mm.

As shown in FIG. 1B, electronic component 1 usually includes a pair of frame terminals 21. However, the number of frame terminals 21 is not limited thereto, and may be one or three or more.

In frame terminal 21, plating layer Y is formed on a surface of a base material (hereinafter, also referred to as base material X).

Base material X is formed of, for example, a metal such as copper, iron, nickel, or aluminum, or a metal alloy such as chromium copper. As plating layer Y, a nickel plating layer is usually formed on a surface of base material X, and a tin plating layer is formed on a surface of the nickel plating layer on a side opposite to base material X. Plating layer Y usually includes an intermetallic compound layer of nickel and tin formed at a boundary between the nickel plating layer and the tin plating layer.

Frame terminal 21 includes covered portion 21A and exposed portion 21B.

Covered portion 21A is a portion covered with exterior body 31. That is, covered portion 21A is a portion from a distal end of frame terminal 21 on a side of covered portion 21A to a portion exposed from exterior body 31. More specifically, as illustrated in FIG. 1B, covered portion 21A has, for example, a portion layered on the bottom surface of electric element 11, a portion bent from this portion and disposed along the side surface of electric element 11, and a portion bent from this portion and exposed from exterior body 31.

Exposed portion 21B is a portion exposed from the side surface of exterior body 31. Exposed portion 21B includes first bent portion 21Ba and first extension portion 21Bb. First bent portion 21Ba is a portion where frame terminal 21 led out from exterior body 31 is bent along the side surface of exterior body 31. In other words, first bent portion 21Ba is a portion where the direction of the length direction of frame terminal 21 changes from the end portion of covered portion 21A to the end portion of first extension portion 21Bb. First extension portion 21Bb is a portion extending from the end portion of first bent portion 21Ba toward the bottom surface of exterior body 31.

In electronic component 1 of the present exemplary embodiment, a crack may be formed in plating layer Y in first bent portion 21Ba. Even in a case where a crack is formed in plating layer Y of first bent portion 21Ba, in electronic component 1 of the present exemplary embodiment, the thickness of plating layer Y of covered portion 21A is small, and plating layer Y is not sufficient to form granular plating. Therefore, it is considered that electronic component 1 of the present exemplary embodiment can suppress the occurrence of granular plating due to reflow heating at the time of mounting.

As illustrated in FIG. 1B, usually, frame terminal 21 includes second bent portion 21Bc which is bent along the bottom surface of exterior body 31 at a tip of first extension portion 21Bb, and includes second extension portion 21Bd which is extended along the bottom surface of exterior body 31 from an end portion of second bent portion 21Bc at a tip of second bent portion 21Bc.

In electronic component 1, as shown in FIG. 3B, the thickness (hereinafter, also referred to as thickness (b)) of plating layer Y near first bent portion 21Ba of first extension portion 21Bb is greater than the thickness (hereinafter, also referred to as thickness (a)) of plating layer Y in covered portion 21A. The phrase of “near first bent portion of first extension portion” means a region of first extension portion 21Bb adjacent to first bent portion 21Ba. That is, the phrase of “near first bent portion of first extension portion” means an end portion of first extension portion 21Bb on a side of first bent portion 21Ba.

Thickness (a) is, for example, equal to or greater than 1 μm and equal to or less than 10 μm, preferably equal to or greater than 2 μm and equal to or less than 7 μm, and more preferably equal to or greater than 3 μm and equal to or less than 6 μm. Thickness (b) is, for example, equal to or greater than 3 μm and equal to or less than 20 μm, preferably equal to or greater than 4 μm and equal to or less than 15 μm, and more preferably equal to or greater than 6 μm and equal to or less than 10 μm.

The ratio of thickness (b) to thickness (a) (thickness (b)/thickness (a)) is preferably equal to or greater than 1.1, more preferably equal to or greater than 1.5, still more preferably equal to or greater than 2, and particularly preferably equal to or greater than 3. The upper limit of the ratio is not particularly limited, but is preferably, for example, equal to or less than 8, and more preferably equal to or less than 5.

The thickness of plating layer Y in first extension portion 21Bb is preferably greater than the thickness of plating layer Y of covered portion 21A over 200 μm or more from the portion led out from exterior body 31 of frame terminal 21. In this case, since the portion where the thickness is large is long, the effect of suppressing the occurrence of granular plating can be further improved. A portion of first extension portion 21Bb having a thickness greater than the thickness of plating layer Y of covered portion 21A is more preferably 250 μm or more, still more preferably 300 μm or more from a portion of frame terminal 21 led out from exterior body 31.

### <Method for Manufacturing Electronic Component>

The method for manufacturing an electronic component according to the present exemplary embodiment includes first to sixth steps. Electronic component 1 of the present exemplary embodiment described above can be easily manufactured by the method for manufacturing an electronic component of the present exemplary embodiment. Hereinafter, the steps will be described in detail.

### [First Step]

In this step, electric element 11 is prepared. Electric element 11 may include, for example, a multilayer varistor and a solid electrolytic capacitor.

### [Second Step]

In this step, frame terminal 21 including a plating layer Y on a surface is prepared. In frame terminal 21, for example, a nickel plating layer and a tin plating layer are usually formed on the surface of base material X including copper or chromium copper.

### [Third Step]

In this step, electric element 11 and frame terminal 21 are electrically connected. Specifically, in this step, in a case where electric element 11 is a multilayer varistor, the external electrode of the multilayer varistor and frame terminal 21 can be joined using, for example, a conductive adhesive such as a silver paste.

### [Fourth Step]

In this step, by covering electric element 11 and a part of frame terminal 21 with exterior body 31 having insulation properties, covered portion 21A covered with exterior body 31 and exposed portion 21B exposed from the side surface of exterior body 31 are formed in frame terminal 21.

Specifically, in this step, electric element 11 and frame terminal 21 are disposed in a mold so as to include a part of frame terminal 21 and electric element 11, and then, for example, a thermosetting resin or the like including an inorganic filler is injected into the mold under pressure, that is, transfer molding is performed to form exterior body 31. As a result, frame terminal 21 can be provided with covered portion 21A and exposed portion 21B, and frame terminal 21 in a state of not being bent at exposed portion 21B can be obtained.

### [Fifth Step]

In this step, electric element 11 and frame terminal 21 covered with exterior body 31 are subjected to heat treatment at a temperature equal to or greater than the melting point of plating layer Y.

Specifically, in this step, in a case where plating layer Y is formed by forming a tin plating layer on the surface of the nickel plating layer, the entire exterior body 31 including electric element 11 and frame terminal 21 therein is subjected to heat treatment at a temperature of equal to or greater than 233° C. which is the melting point of tin. As a result, the metal such as tin in plating layer Y of covered portion 21A of frame terminal 21 melts and moves to plating layer Y of exposed portion 21B, and as a result, the thickness of plating layer Y in exposed portion 21B of frame terminal 21 is less than the thickness of plating layer Y in covered portion 21A.

### [Sixth Step]

In this step, after the fifth step, frame terminal 21 is bent along the side surface of exterior body 31 at exposed portion 21B.

After the sixth step, a crack may be formed in plating layer Y of the bent portion obtained by bending frame terminal 21. Even in a case where a crack is formed in the bent portion obtained by bending frame terminal 21, in electronic component 1, the thickness of plating layer Y of covered portion 21A is small, and there is no enough metal such as tin to form granular plating. Therefore, it is considered that electronic component 1 can suppress the occurrence of granular plating due to reflow heating during mounting.

Specifically, in this step, frame terminal 21 is bent along the side surface of exterior body 31 in exposed portion 21B by using, for example, a roller to form first bent portion 21Ba.

In a case where the bending in the sixth step is performed without performing the heat treatment in the fifth step, before the sixth step, as shown in FIG. 4A, the thickness of plating layer Y on the surface of base material X in exposed portion 21B of frame terminal 21 is the same as the thickness of plating layer Y in covered portion 21A. As described above, in a case where the bending in the sixth step is performed in a state where the thickness of plating layer Y of exposed portion 21B and covered portion 21A is the same, as shown in FIG. 4B, crack W is easily formed in first bent portion 21Ba. In a case where crack W is formed, the plating layer Y which has been molten and discharged to the outside of exterior body 31 cannot be wet and spread on exposed portion 21B of frame terminal 21 at the time of reflow heating at the time of mounting, and granular plating occurs.

On the other hand, in a case where the bending is performed in the sixth step after the heat treatment in the fifth step is performed, the thickness of plating layer Y on the surface of base material X in exposed portion 21B of frame terminal 21 is greater than the thickness of plating layer Y in covered portion 21A by the heat treatment in the fifth step as illustrated in FIG. 3A. As described above, in a case where the bending in the sixth step is performed in a state where the thickness of plating layer Y is greater in exposed portion 21B than in covered portion 21A, as shown in FIG. 3B, a crack is less likely to be formed in first bent portion 21Ba.

As described above, according to the method for manufacturing an electronic component of the present exemplary embodiment, by performing the bending in the sixth step following the heat treatment in the fifth step, it is possible to suppress the plating crack in the bent portion of frame terminal 21. In addition, since the heat treatment in the fifth step is performed before the bending in the sixth step, the molten metal such as tin or the like that has moved from covered portion 21A of frame terminal 21 to exposed portion 21B is prevented from being cracked by plating at exposed portion 21B, and can wet and spread, and accordingly, the occurrence of granular plating can be prevented.

### CONCLUSION

As apparent from the above exemplary embodiments, the present disclosure includes the aspects described below.

Electronic component (1) according to a first aspect includes electric element (11), frame terminal (21), and exterior body (31). Frame terminal (21) includes plating layer (Y) on a surface of the frame terminal (21), and is electrically connected to electric element (11). Exterior body (31) covers electric element (11) and a part of frame terminal (21), has a side surface and a bottom surface, and has insulation properties. Frame terminal (21) includes covered portion (21A) covered with exterior body (31), and exposed portion (21B) exposed from the side surface of exterior body (31). Exposed portion (21B) includes first bent portion (21Ba) where frame terminal (21) led out from exterior body (31) is bent along the side surface, and first extension portion (21Bb) extending from first bent portion (21Ba) toward the bottom surface of exterior body (31). Plating layer (Y) near first bent portion (21Ba) of first extension portion (21Bb) has a thickness greater than a thickness of plating layer (Y) in covered portion (21A).

According to the first aspect, occurrence of granular plating due to reflow heating during mounting can be suppressed.

In electronic component (1) according to a second aspect, in the first aspect, plating layer (Y) in first bent portion (21Ba) has a crack.

According to the second aspect, the effect of suppressing the occurrence of granular plating can be exhibited even when a crack is formed in first bent portion (21Ba).

In electronic component (1) according to a third aspect, in the first or second aspect, plating layer (Y) in first extension portion (21Bb) has a thickness greater than a thickness of plating layer (Y) in covered portion (21A) over 200 μm or more from a portion led out from exterior body (31) of the frame terminal (21).

According to the third aspect, the effect of suppressing the occurrence of granular plating can be further improved.

In electronic component (1) according to a fourth aspect, in any one of the first to third aspects, frame terminal (21) includes plating layer (Y) formed on a surface of base material (X), base material (X) includes copper or chromium copper, and plating layer (Y) includes tin.

According to the fourth aspect, frame terminal (21) in which base material (X) includes copper or chromium copper has low toughness, tin of plating layer (Y) has a low melting point, and plating cracking and granular plating are likely to occur, and thus the use of the present technology is highly beneficial.

In electronic component (1) according to a fifth aspect, in any one of the first to fourth aspects, plating layer (Y) includes an intermetallic compound layer of tin and nickel.

According to the fifth aspect, since plating layer (Y) includes the tin-nickel intermetallic compound layer, wettability of the molten metal of plating layer (Y) can be further improved, and as a result, the effect of suppressing the occurrence of granular plating can be further improved.

In electronic component (1) according to a sixth aspect, in any one of the first to fifth aspects, electric element (11) is a multilayer varistor.

According to the sixth aspect, reliability such as heat resistance and moisture resistance of the multilayer varistor can be improved by using the multilayer varistor as electric element (11).

A method for manufacturing electronic component (1) according to a seventh aspect includes: a first step of preparing electric element (11); a second step of preparing frame terminal (21) including plating layer (Y) on a surface; a third step of electrically connecting electric element (11) and frame terminal (21); a fourth step of covering electric element (11) and a part of frame terminal (21) with exterior body (31) having insulation properties and forming covered portion (21A) covered with exterior body (31) and exposed portion (21B) exposed from a side surface of exterior body (31) in frame terminal (21); a fifth step of performing heat treatment to electric element (11) and frame terminal (21) covered with exterior body (31) at a temperature equal to or greater than a melting point of plating layer (Y); and a sixth step of bending frame terminal (21) along a side surface of exterior body (31) at exposed portion (21B) after the fifth step.

According to the seventh aspect, it is possible to easily manufacture electronic component (1) capable of suppressing occurrence of granular plating due to reflow heating during mounting.

In the method for manufacturing electronic component (1) according to an eighth aspect, in the seventh aspect, in the fifth step, a thickness of plating layer (Y) at exposed portion (21B) of frame terminal (21) is greater than a thickness of plating layer (Y) at covered portion (21A).

According to the eighth aspect, it is possible to easily form a structure in which the thickness of plating layer (Y) in exposed portion (21B) is greater than that of covered portion (21A).

In the method for manufacturing electronic component (1) according to a ninth aspect, in the seventh or eighth aspect, in the sixth step, a crack is formed in plating layer (Y) of the bent portion where frame terminal (21) is bent.

According to the ninth aspect, the effect of suppressing the occurrence of granular plating can be achieved even in a case where a crack is formed in the bent portion.

In the method for manufacturing electronic component (1) according to a tenth aspect, in any one of the seventh to ninth aspects, electric element (11) is a multilayer varistor.

According to the tenth aspect, reliability such as heat resistance and moisture resistance of the multilayer varistor can be improved by using the multilayer varistor as electric element (11).

The electronic component and the method for manufacturing the electronic component according to the present disclosure can suppress occurrence of granular plating due to reflow heating during mounting, and thus can suppress occurrence of short circuit or the like on the mount board. As described above, the electronic component and the method for manufacturing the electronic component according to the present disclosure are industrially useful.

What is claimed is:

1. An electronic component comprising:
an electric element;
a frame terminal that includes a plating layer on a surface of the frame terminal and is electrically connected to the electric element; and
an exterior body that covers the electric element and a part of the frame terminal, has a side surface and a bottom surface, and has insulation properties,
wherein the frame terminal includes a covered portion covered with the exterior body, and an exposed portion exposed from the side surface of the exterior body,
the exposed portion includes a first bent portion where the frame terminal led out from the exterior body is bent along the side surface, and a first extension portion extending from the first bent portion toward the bottom surface of the exterior body, and
the plating layer near the first bent portion of the first extension portion has a thickness greater than a thickness of the plating layer in the covered portion.

2. The electronic component according to claim 1,
wherein the plating layer in the first bent portion has a crack.

3. The electronic component according to claim 1,
wherein the plating layer in the first extension portion has a thickness greater than a thickness of the plating layer in the covered portion over 200 μm or more from a portion led out from the exterior body of the frame terminal.

4. The electronic component according to claim 1,
wherein the frame terminal includes a plating layer formed on a surface of a base material,
the base material includes copper or chromium copper, and
the plating layer includes tin.

5. The electronic component according to claim 1,
wherein the plating layer includes an intermetallic compound layer of tin and nickel.

6. The electronic component according to claim 1,
wherein the electric element is a multilayer varistor.

7. A method for manufacturing an electronic component, the method comprising:
a first step of preparing an electric element;
a second step of preparing a frame terminal including a plating layer on a surface;
a third step of electrically connecting the electric element and the frame terminal;
a fourth step of, by covering the electric element and a part of the frame terminal with an exterior body having insulation properties, forming a covered portion covered with the exterior body and an exposed portion exposed from a side surface of the exterior body in the frame terminal;
a fifth step of performing heat treatment to the electric element and the frame terminal covered with the exterior body at a temperature equal to or greater than a melting point of the plating layer; and
a sixth step of bending the frame terminal along a side surface of the exterior body at the exposed portion after the fifth step.

8. The method for manufacturing the electronic component according to claim 7,
wherein in the fifth step, a thickness of the plating layer at the exposed portion of the frame terminal is greater than a thickness of the plating layer at the covered portion.

9. The method for manufacturing the electronic component according to claim 7,
wherein in the sixth step, a crack is formed in the plating layer of a bent portion where the frame terminal is bent.

10. The method for manufacturing the electronic component according to claim 7,
wherein the electric element is a multilayer varistor.
